(19) United States
(12) Patent Application Publication
(10) Pub. No.: US 2009/0173869 A1
(43) Pub. Date: Jul. 9, 2009

(54) CANTILEVER STRUCTURE OF MOUNTING FRAME

(76) Inventor: YI-CHUNG SU, Taipei (TW)

Correspondence Address: G. LINK CO., LTD., 3550 BELL ROAD, MINOOKA, IL, 60447, US

(21) Appl. No.: 12/022,152

(22) Filed: Jan. 29, 2008

(30) Foreign Application Priority Data
Jan. 7, 2008 (TW) 097200368

(51) Int. Cl. F16M 13/00

(52) U.S. Cl. 248/629; 248/617

(57) ABSTRACT

The present invention relates to a cantilever structure of mounting frame that uses mainly the arc tracks of a first through-slot member and a second through-slot member on a flange to produce different tensile elongations of the elastic element such that the mounting frame can stay firmly at the adjusted position under the bearing created by different angles.

### FIELD OF THE INVENTION

The present invention relates to a cantilever structure of mounting frame, more particularly a cantilever structure composed of an elastic element coupled with arc-shaped through-slot members.

### BACKGROUND OF THE INVENTION

The dawning of digital age, prevalence of the Internet, and changes of digital broadcast signals have fueled the significant evolvement of display technology. Flat panel display (FPD) monitors offer the advantages of lightweight, thin form, power saving and free of radiation. It is expected to become the mainstream choice for computer monitor and home television.

Generally a stand is needed for the placement of FPD monitor on a desk for support and fixation or the adjustment of monitor angle.

In recent ears. FPD monitor stand and FPD arc commonly separately fabricated and then assembled. When a stand-included FPD monitor is placed on a desk, it is also easy to adjust the tilting angles of the LCD.

Because of poor mechanical design, mounts of prior art for display monitor are at times over-loaded or tend to displace after angle adjustment, resulting in a situation where the adjusted angle is not what the user desires. The present invention aims to address this drawback of display mount.

### SUMMARY OF THE INVENTION

The invention relates to a cantilever structure of mounting frame that uses mainly the arc tracks of a first through-slot member and a second through-slot member on a flange to produce different tensile elongations of the elastic element such that the mounting frame can stay firmly at the adjusted position under the bearing created by different angles.

The invention comprises a holder in block configuration, the holder being extended on the same face with a first flange and a second flange paired and parallelly adjacent to each other, a first space member being situated between the first flange and the second flange, the first flange and the second flange being respectively configured with a first axle hole, a second axle hole, a first through-slot member and a second through-slot member; a cantilever assembly consisting of a first arm and a second arm, the first arm and the second arm having a Π-shaped long plate configuration and forming a hollow configuration when adjoined together, the first arm and the second arm also having on the same side respectively a third axle hole, a fourth axle hole, a third through-slot member and a fourth through-slot member, wherein the first axle hole can be coaxially coupled to the third axle hole, the second axle hole can be coaxially coupled to the fourth axle hole, the first through-slot member can be coupled to the third through-slot member, and the second through-slot member can be coupled to the fourth through-slot member, and the first through-slot member, the second through-slot member, the third through-slot member, and the fourth through-slot member can be assembled together with the insertion of a latch shaft: and an elastic element which is a spring and disposed between the first arm and the second arm, one end of the elastic element being attached to the latch shaft and the other end of the elastic element being attached to the same other end of the first space member as the first arm and the second arm such that the mounting frame can stay firmly at the adjusted position under the bearing created by different angles.

The objects, features and effects of the invention are described in detail below with embodiments in reference to the accompanying drawings.

### DESCRIPTION OF THE DRAWINGS

FIG. 1 is an exploded view of a preferred embodiment of the invention;

FIG. 2 is an action diagram 1 of the preferred embodiment of the invention;

FIG. 3 is an action diagram 2 of the preferred embodiment of the invention;

FIG. 4 is an action diagram 3 of the preferred embodiment of the invention; and

FIG. 5 is side view of the preferred embodiment of the invention added with a mount structure and an external shell.

### DETAILED DESCRIPTION OF THE INVENTION

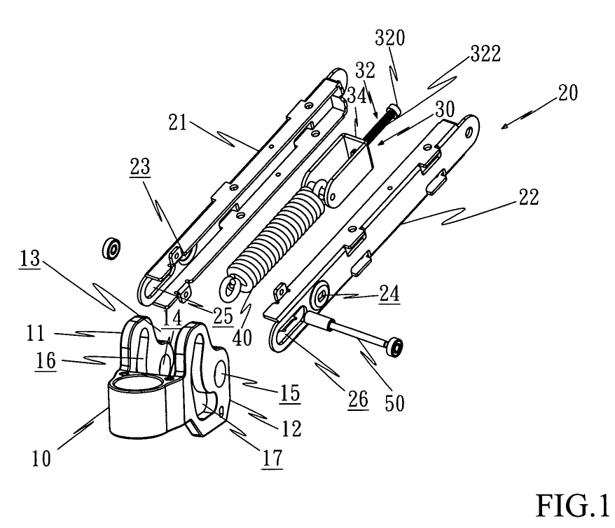

FIG. 1 is an exploded view of a preferred embodiment of the invention. The invention relates to a cantilever structure of mounting frame, comprising mainly of a holder (10), a cantilever assembly (20), an adjusting structure (30), and an elastic element (40). The embodiment is described in details below.

The holder (10) has a block configuration and is extended on the same face with a first flange (11) and a second flange (12) paired and parallelly adjacent to each other, a first space member (13) being situated between the first flange (11) and the second flange (12) the first flange (11) and the second flange (12) being respectively configured with a first axle hole (14), a second axle hole (15), a first through-slot member (16) and a second through-slot member (17), and the first through-slot member (16) and the second through-slot member (17) having mainly an arc-shaped configuration.

The cantilever assembly (20) consists of a first arm (21) and a second arm (22), the first arm (21) and the second arm (22) having mainly a Π-shaped long plate configuration such that a hollow configuration is formed when the first arm (21) and the second arm (22) are adjoined together, the first arm (21) and the second arm (22) also having on the same side respectively a third axle hole (23), a fourth axle hole (24), a third through-slot member (25) and a fourth through-slot member (26), wherein the first axle hole (14) can be coaxially pinpointed to the third axle hole (23), the second axle hole (15) can be coaxially pin-jointed to the fourth axle hole (24), the first through-slot member (16) can be coupled to the third through-slot member (25), and the second through-slot member (17) can oe coupled to the fourth through-slot member (26), and the first through-slot member (16), the second through-slot member (17), the third through-slot member (25), and the fourth through-slot member (26) can be assembled together with the insertion of a latch shaft (50).

The adjusting structure (30) consists of an adjusting screw (32) and an adjusting block (34), the adjusting screw (32) comprising a nut member (320) and a screw thread member (322), the nut member (320) of the adjusting screw (32) being arranged on the external surface of the cantilever assembly (20), the screw thread member (322) of the adjusting screw (32) penetrating through the cantilever assembly (20) and threading through one end of the adjusting block (34).

The elastic element (40) is a spring and disposed in a hollow space formed after the first arm (21) and the second arm (22) are assembled, one end of the elastic element (40) being attached to the latch shaft (50) situated in the first space member (13) and the other end of the elastic element (40) being attached to the other end of the adjusting block (34) such that turning the adjusting screw (32) will adjust the bearing force the elastic element (40) is subject to.

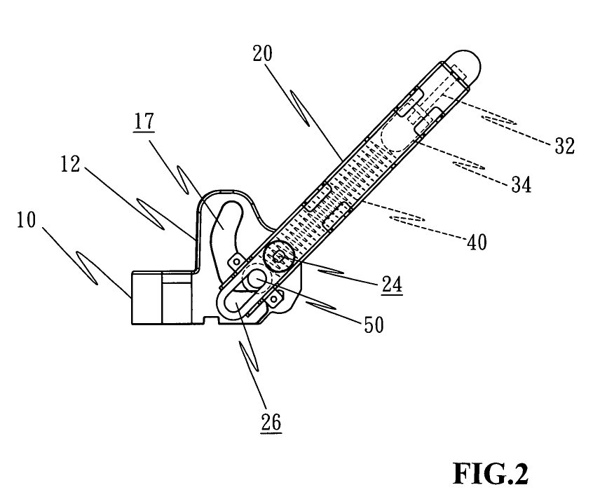

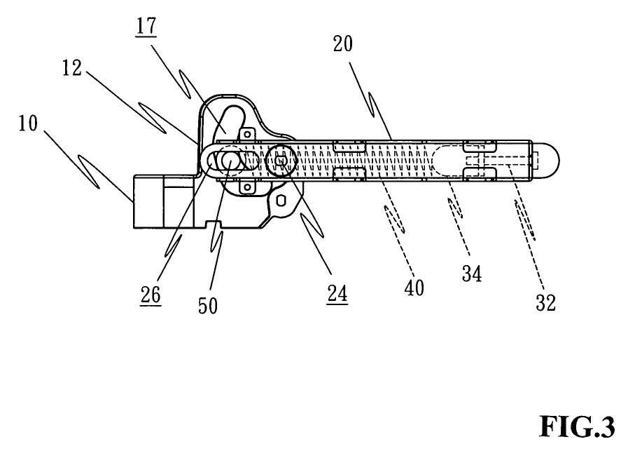

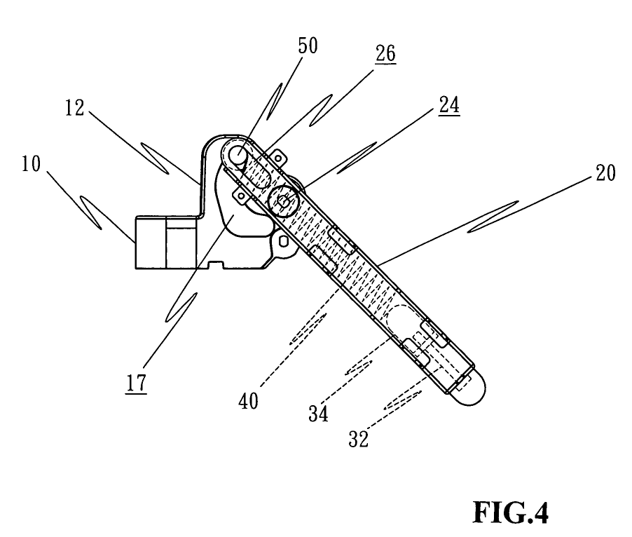

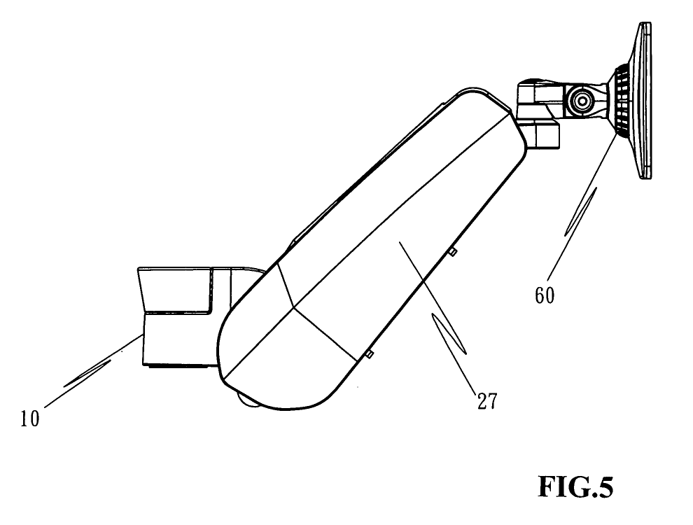

Referring to FIGS. 2, 3, 4 and 5, FIG. 2 is an action diagram 1 of the preferred embodiment of the invention; FIG. 3 is an action diagram 2 of the preferred embodiment of the invention; FIG. 4 is an action diagram 3 of the preferred embodiment of the invention: and FIG. 5 is side view of the preferred embodiment of the invention added with a mount structure and an external shell. As shown, the assembled mounting frame can be coupled with a mount structure (60) and covered by a shell (27) over the cantilever assembly (20) to make it more aesthetic. The mount structure (60) hangs primarily a display device (not shown in the figure). First of all, the adjusting screw (32) is turned to adjust the restoring force of the elastic element (40) to proper magnitude. When the cantilever assembly (20) turns under an external force, it will turn around the fourth axle hole (24) (the first axle hole (14), the second axle hole (15), the third axle hole (23), and the fourth axle hole (24) have the same axle center), where the latch shaft (50) will move along with the location of space appeared as the second through-slot member (17) and the fourth through-slot member (26) overlap (similarly along with the location of space appeared as the first through-slot member (16) and the third through-slot member (25) overlaps), which at the same time changes the tensile elongation of the elastic element (40) where different restoring force is accumulated on the elastic element (40) such that when the external force is removed, the weight of the display device hung on the mount structure (60) can be offset by the restoring force provided by the elastic element (40) and the frictional force arising from the pin-jointed assembly of the first axle hole (14), the second axle hole (15), the third axle hole (23), and the fourth axle hole (24). As such, after external force is removed, the display device hung on the mount structure (60) will not produce extra displacement.

The cantilever structure of mounting frame provided by the invention achieves the objects of the invention using an elastic element coupled with arc-shaped through-slots. Thus the invention possesses inventiveness and meets the essential criteria for a patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A cantilever structure of mounting frame, comprising:
a holder in block configuration, the holder being extended on the same face with a first flange and a second flange paired and parallelly adjacent to each other, a first space member being situated between the first flange and the second flange, the first flange and the second flange being respectively configured with a first axle hole, a second axle hole, a first through-slot member and a second through-slot member;
a cantilever assembly consisting of a first arm and a second arm, the first arm and the second arm having a Π-shaped long plate configuration and forming a hollow configuration when adjoined together, the first arm and the second arm also having on the same side respectively a third axle hole, a fourth axle hole, a third through-slot member and a fourth through-slot member, wherein the first axle hole can be coaxially coupled to the third axle hole, the second axle hole can be coaxially coupled to the fourth axle hole, the first through-slot member can be coupled to the third through-slot member, and the second through-slot member can be coupled to the fourth through-slot member, and the first through-slot member, the second through-slot member, the third through-slot member, and the fourth through-slot member can be assembled together with the insertion of a latch shaft; and
an elastic element which is a spring and disposed between the first arm and the second arm, one end of the elastic element being attached to the latch shaft and the other end of the elastic element being attached to the same other end of the first space member as the first arm and the second arm.

2. The cantilever structure of mounting frame according to claim 1, wherein the first through-slot member and the second through-slot member are in arc-shaped configuration.

3. The cantilever structure of mounting frame according to claim 1, further comprising an adjusting structure, the adjusting structure consisting of an adjusting screw and an adjusting block, a nut member of the adjusting screw being disposed on the external surface of the cantilever assembly, a screw thread member of the adjusting screw penetrating through the cantilever assembly and threading through one end of the adjusting block, the other end of elastic element being attached to the adjusting block.
